(19) United States
(12) Patent Application Publication
(10) Pub. No.: US 2012/0144327 A1
(43) Pub. Date: Jun. 7, 2012

(54) WEBSITE FILE AND DATA STRUCTURE, WEBSITE MANAGEMENT PLATFORM AND METHOD OF MANUFACTURING CUSTOMIZED, MANAGED WEBSITES

(75) Inventors: Samuel L. Johnson, Lacey, WA (US); James Beal, JR., Eagan, MN (US); William E. Pelton, SR., St. Peter, MN (US)

(73) Assignee: BIZIDEO LLC, Eagan, MN (US)

(21) Appl. No.: 13/309,161

(22) Filed: Dec. 1, 2011

Related U.S. Application Data
(60) Provisional application No. 61/418,567, filed on Dec. 1, 2010.

(51) Int. Cl. G06F 3/048

(52) U.S. Cl. 715/763

(57) ABSTRACT

A website design tool that is adapted to be presented on a computer display screen includes a console, a plurality of webpage design widgets and a user interface where the console is displayable on the computer screen and presents an image of what will ultimately be seen by a webpage visitor. The user interface enables a webpage designer to drag and drop content from the webpage design widgets onto airy arbitrary location within the console's borders.

This application claims priority to provisional application Ser. No. 61/418,567, filed Dec. 1, 2010, the contents of which are incorporated by reference herein.

### BACKGROUND

1. Field of the Invention

The present invention relates to web application development tools and management systems, and mote particularly to a web application development tool and management system that improves the ease of designing, organizing and managing web applications, such as webpage or web application resources.

2. Discussion of the Prior Art

In the past, the design of a website for a company or other entity has typically involved two different and isolated tasks—the creative task and the technical task. The creative task involves the selection, layout and design of the content that will be displayed to visitors to the website. The technical task involves the software coding, as well as the other implementation work that enable the selected, and designed content to be displayed in the desired manner.

Because these two tasks have often been carried out in the past by different individuals or different groups of individuals, the design and management of web applications, such as webpages, has tended to be cumbersome. For example, if a company wishes to create a website in which some visitors are permitted access to certain content and other visitors are not permitted access, such as those visitors who don't pay a fee or otherwise satisfy the desired criteria, those details are worked out by the creative designers. They are then forwarded to the technical team for implementation. During the implementation phase, changes may he made to the creative criteria in order to implement the functionality in a feasible manner. Alternatively, if no changes are made, the creative team may not approve of the content after the technical processing is finished and they can view the website in action and interact with it. In either case, the creative team may need to make further revisions which are then passed onto the technical team, and this cycling back and forth between the two teams can persist for undesirable lengths of time and which necessarily adds to the cost of the website development effort.

### SUMMARY OF THE INVENTION

The present invention provides systems and methods for improving the website design and management process. In at least one embodiment, the systems and methods merge the creative and technical aspects of website design such that Individuals with little or no website or webpage technical design skills are able to create a wide variety of different content, view the content as it will appear in the final product, and implement the desired functionality—all without having to either learn the technical, details necessary for the implementation or to wait for other individuals with the knowledge of the technical details to complete the implementation. Among the many benefits of the various systems and methods is the ability to perform speed publishing or expedited content or system provisioning.

In this embodiment, a webpage design, tool is provided that is adapted to operate on a computer having a display screen. The development tool includes a console, a plurality of webpage design, widgets, and a user interlace. As used herein, “console” may be defined as the area of a webpage intended to fit naturally in the computer display and “webpage design widgets” as graphics, text or media that can appear on a webpage and behave independently or dependently. The console is displayable upon, the screen and shows an image of what will be seen by a visitor to the webpage being designed using the development tool The webpage design widgets ate also displayable upon the screen and each of the plurality of webpage design widgets correspond to a type of content that is to be displayed on the console. The user interface enables a webpage designer to drag and drop content front the webpage design, widgets onto any location within the borders of the console whereby the content will be displayed on the webpage being developed at the same location as the content is positioned on the console relative to the console's location and size.

According to other embodiments, the webpage design widgets may include a web application programming interface (API) that interfaces with an Internet accessible resource. The API has the ability to interact with a payment tool for accepting credit card information and for charging an account associated with the credit card information. Alternatively, the API may have the ability to interact with a map fool for presenting maps of locations or with a social network website or with any other desirable API. The widgets also preferably have the ability to enable a user to view and alter its properties for displaying content and functionality associated with the appearance and behavior of the widget and its properties. Such properties may typically include size, shape, background, border, color, shadows, type faces and possibly other such properties as display options that are contingent upon a particular visitor to the webpage or a particular type of visitor to the webpage and/or a set of conditions that may apply, such, as first-time visit or a statistical threshold being reached.

In other embodiments, the widgets of the tool may allow an advertisement to be placed on the webpage. The widgets may include a first widget for selecting a player, a second widget for selecting playlists, a third widget for selecting images, a fourth widget for selecting rich content, a fifth widget for selecting plain text and any number of additional widgets.

In any of the mentioned embodiments, die tool may include an upload feature for uploading the console in its entirety or partially over the Internet to a service provider, wherein, the service provider then communicates a software link to the uploaded console to a user of the tool. The software link may then he used to provide a link from a website maintained by an entity other than the service provider to the webpage that was designed on the console.

After uploading the console to the service provider, the service provider may provide backend support for at least one of the APIs. Such backend support may be offered for a variety of different APIs, including, but not limited to, a mechanism for accepting online financial payments from a visitor to the website.

The widgets may include rule settings for allowing selected content to be displayed only to visitors to the website who have made an on-line financial payment or only to visitors who meet other selectable criteria. The tool may further include widgets enabling a user of the tool to create a second console or multiple additional consoles on the network that link to one or more previously published consoles. One or more widgets may also be intended that enable a user of the tool to select different content for display on the webpage based upon different categories of visitors to the webpage.

in still other embodiments, the webpage development tool of the present invention enables the creation of different content that is accessible to different types of visitors while also enabling the display of the different content to the development tool user in the same manner as the content would be displayed to an actual visitor to the webpage and the tool displays the different content to the user without requiring the user to actually visit the webpage. The tool may also include an enterprise configuration adapted to enable a first set of individuals to develop a defined layout of a template for the console such that a second set of individuals who use the tool are limited to designing webpages that are in conformance with the defined layout or template.

In still other embodiments, the systems and methods of the present invention provide a strategy and a data structure for developing and delivering personalized, rich media and/or video-enhanced online content systems, A method of developing patterns of data is provided, that enable the pairing of user identifications with contextually relevant groups of features and content in controlled layouts. The systems and methods described herein provide the ability to save manipulations of webpages and/or webpage resources using the design tool and to define codes or groups of codes that achieve specific web content/feature delivery goals.

According to still other aspects, the systems and methods include a structure, fixed-width code that can be mapped to organization scenarios that relate content and features to users. Such codes may be extendable with domain-directory-document hierarchical organization (e.g. subdomain.domain.tld/director/code).

Design widgets may be provided having a simple HTML5/CSS3 and JavaScript framework and coding convention for adding features and functionality to a page layout. The widgets may also individually include a data and file organization model for enabling configurable presentation, right click context (or other event-driven context) controls and parameterization of HTML, JavaScript or other coded scripts that, execute within a container or defined zone on a webpage.

The web development tool may be a scalable, portable HTML/Javascript/PHP framework and coding convention for manipulating widgets and structured fixed-width codes using layouts. The tool may comprise a data model and intuitive drag-and-drop manager for hierarchical web file and data organization, control and navigation.

The system may use multivariate remote session tokens, which may he a single code that can represent an advanced control or stewardship relationship—over features, content, layout or integration—for a user, group role or channel. Such tokens may also comprise groups of codes for a single user or content item that can represent relationships between users and widgets on a rules-based, scheduled, profile or other basis, enabling content or feature subscriptions, pay per view delivery, security, media management/transcoding and personalization. Such tokens provide a distributed, interchangeable with client programming and cloud-friendly coding convention and a single sign-on approach for integrating video and virtual response programming components across web domains.

It can be seen, then, that the present invention provides a webpage management and hosting system that enables any user to design and control a powerful, interactive website that leverages virtually any type of on-line content or access device.

The present invention allows non-technical individuals having limited computer programming experience to design, create and manage dynamic websites. Using on-line video for a business can be expensive, technical, slow in implement and unnecessarily complicated. The present webpage design tool allows creation of webpages with unprecedented interactivity and ease of design and launch, and an affordable tool for small businesses as well as enterprises.

### BRIEF DESCRIPTION OF THE DRAWINGS

The foregoing features, objects and advantage of the invention will become apparent to those skilled in the from the following detailed description of a preferred embodiment, especially when, considered in conjunction with the accompanying drawings in which like numbers in the several view refer to corresponding parts.

FIG. 1 is a block diagram of a webpage design tool according to one aspect of the present invention;

FIG. 2 is a diagram of an illustrative hardware environment in which one or more embodiments of the webpage design tool, as well as a webpage management system, may be implemented;

FIG. 3 is an illustrative screen shot of a web design tool according to one embodiment showing a configurable background and a plurality of webpage design widgets selectable from a widget window;

FIG. 4 is an illustrative screen shot of the tool of FIG. 3 showing a player widget being selected;

FIG. 5 is an illustrative screen shot of the tool of FIG. 3 showing a playlist widget that has been selected:

FIG. 6 is an illustrative screen shot, of the web development tool of FIG. 3 showing one way in which properties of videos in a playlist may be edited;

FIG. 7 is an illustrative screen shot of the tool, of FIG. 3 showing a playlist editing widget, a video library window and a playlist;

FIG. 8 is an illustrative screen shot of the tool of FIG. 3 showing, a sample layout of a webpage that may be designed with, the tool;

FIG. 9 is an illustrative screen shot of the tool of FIG. 3 showing another sample layout of a webpage that may be designed with the tool;

FIG. 10 is an illustrative screen shot of a billing and account window that can be made to appear using the tool of FIG. 3 when a webpage is to be uploaded;

FIG. 11 is an illustrative screen shot, of a login window that may appear with the tool of FIG. 3 for an established customer;

FIG. 12 is a schematic diagram of how the various components of one embodiment of the web design tool may be used to create one-to-one or near one-to-one experiences tor visitors to a particular website;

FIG. 13 is a chart illustrating various, types of visitor data that may be gathered about visitors to one or more webpages designed using the web design tool; and

FIG. 14 is a software flow diagram illustrating the operations involved in programming the web design tool of the present invention.

### DETAILED DESCRIPTION OF THE EMBODIMENTS

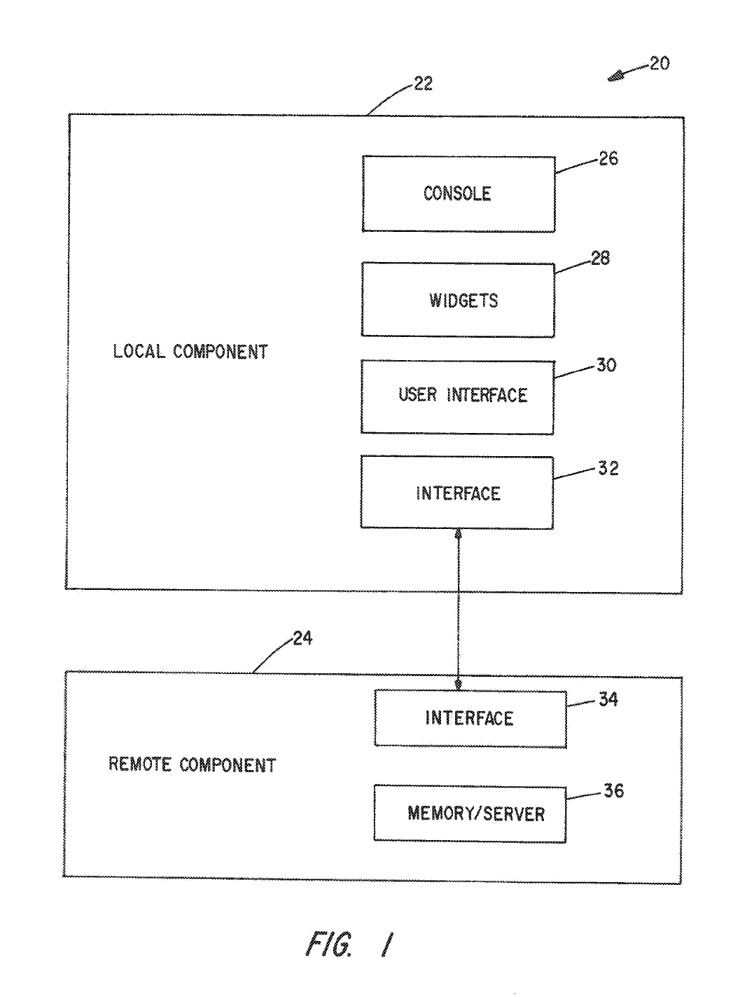

A webpage design tool according, to one embodiment is shown in block diagram form in FIG. 1 and is indicated generally by numeral 20. Webpage design tool 20 is a tool that may be used by individuals to design, modify, and/or manage content on a particular website without requiring the individuals to possess detailed technical skills with respect to webpage designs, modifications or management. Tool 20 enables an individual who may not he an IP specialist to speed publish content to a website as well as to target website content to specific classes of visitors. Indeed, in some embodiments, tool 20 may be used to design and/or manage websites in a manner that provides content that is completely personalized to the particular visitor. In such embodiments, tool 20 may he used to create one-to-one experiences for visitors to a particular website.

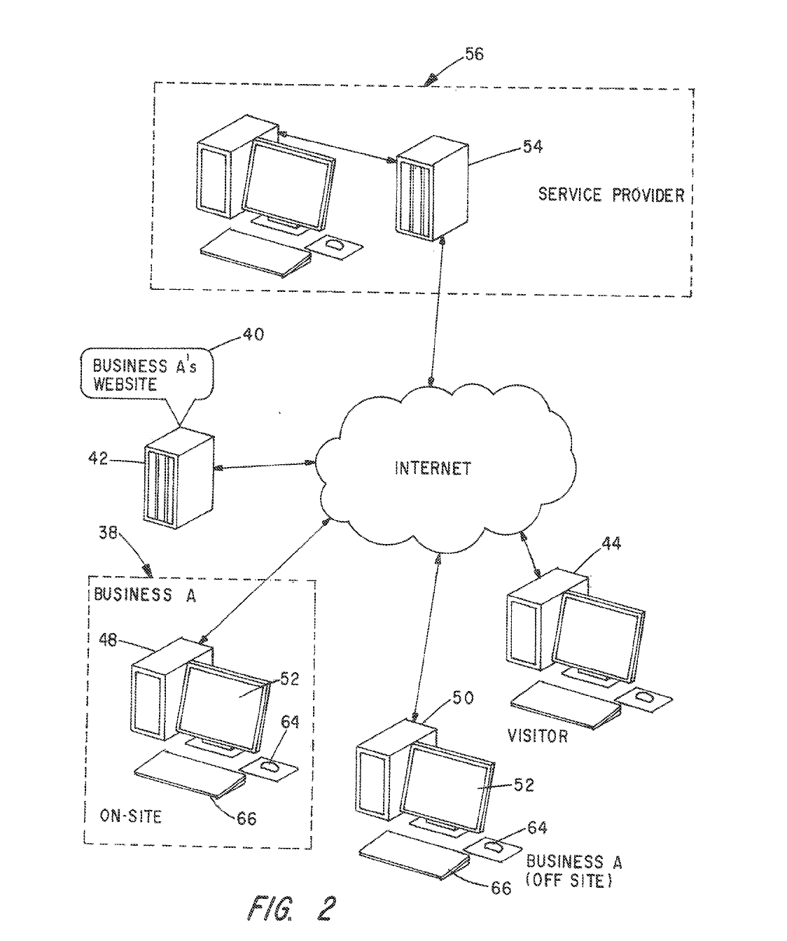

In the embodiment shown in FIG. 1, webpage design tool 20 includes a local component 22 and a remote component 24. Local component 22 includes a console 26, one or more design widgets 28, a user interface 30 and a remote interface 32 for communicating with remote component 24. Additional components of local component 22 may be present, some of which will he discussed in greater detail below. Remote component 24 includes a local interface 34 and a memory 36, which may he in communication, with, or integrated into, one or more servers, such as server 54 in FIG. 2. Remote component 24 may further include additional, components, some of which will be discussed in greater detail below.

Both local and remote components 22 and 24 are comprised primarily of software and/or firmware that are executed on one or more computers, servers, or other electronic devices. It will be understood by those skilled in the art that many of the functions described herein as being carried out by local component 22 may alternatively be carried out by remote component 24, and vice versa. It will also be understood by those skilled in the art that local component 22 and remote component 24 may be combined into a single unit that resides in a single location.

The operation of one embodiment may be better understood with reference to FIG. 2, which illustrates an environment in which component 22 may he used. It will, of course, be understood by those skilled, in the art that tool 20 may be used in other environments. In the embodiment of FIG. 2, an entity has a website 40 that is maintained on one or more servers 42 or other electronic structures capable of storing a website and providing access to the Internet. In the embodiment shown in FIG. 2, entity 38 is referred to as “business A.” However, it will be understood that entity 38 may be a firm, a non-profit, an individual or any other type of entity.

While server 42 is shown In FIG. 2 as residing physically outside of business A, it will be understood that the physical location of server 42 may be changed. Website 40 may be a website that is accessible over the Internet to public visitors or to users who have special access. Website 40 is associated with an IP address that enables visitors to the website to view content using a web browser, whether incorporated into a conventional desktop or laptop computer or a mobile device (e.g. cell phone, smart phone, personal digital assistant, Blackberry, etc). The content of website 40 may be completely stored on server 42 or it maybe stored at locations elsewhere or it may be partially or wholly a web mashup of content gathered from sources using application programming interfaces or other means.

Web development tool 20 enables an individual or group of individuals to manage and/or make updates, additions, modifications and/or deletions to the content of website 40 without requiring the-individual or group of individuals to possess detailed technical knowledge. Broadly speaking, local component 22 may reside on an Internet-accessible computer either on the premises of business A (such as computer 48) or at any other location that is Internet accessible, such as via off-site computer 50. Regardless of its physical location, local component 22 displays console 26 on a display screen 52 associated with the computer, such as, but not limited to, computers 48 or 50. Console 26 provides an electronic “canvas” on which the user may “paint” whatever desired content he or she wishes to include on his or her webpage. Console 26 may act as a wrapper that contains the webpage or web application's contention and functionality. As will be discussed in greater detail below, tool 20 provides a rich array of different types of content that may he applied to console 26. The application of such content to the console is facilitated by a plurality of design widgets whose various functions will also be described in greater detail below.

After the user has completed the design of his or her webpage, he or she may then upload the content he or she has placed on the console to remote component 24 via the Internet. In the environment shown m FIG. 2, remote component 24 may be stored on a server 54 operated by a service provider 56. The uploading of the content to server 54 may often be preceded by paying a fee and/or registering an account with service provider 56.

As an alternative to uploading the content of console 26 to server 54, the content of the console may be saved on server 54 without a specific “upload” step. This alternative may be implemented where web development tool 20 operates within a web browser operating on a location computer—such as computers 48 or 50—and the local component 22 is in communication with server 54 throughout the web development process. In such a case, whenever a user of tool 20 adds content to the console, this information is communicated over the Internet to server 54. As a result, server 54 contains in its memory a copy of the current console's configuration that is repetitively updated throughout the design process. When a user finishes the design process, he or she does not need to separately upload the console to server 54 because the latest state of the console is already resident on server 54. Instead, he or she may simply instruct server 54 to permanently store the latest console configuration for later use.

When tool 20 is embodied to operate within a web browser on a location computer, the communication that takes place between local component 22 and remote component 24 (which may operate on server 54) may utilize Ajax (asynchronous JavaScript and XML) calls and server-side scripting (PHP). Client-side scripting may be utilized in rendering the appropriate images on display 52 of the location computer as well as controlling the local functionality of local component 22. Server-side scripting is a web server technology in which a user's request is varied by running a script directly on the web server to generate dynamic webpages. It is usually used to provide interactive websites that interlace to databases or other data stores. This is different from client-side scripting where scripts are run by the viewing web browser, usually in JavaScript (JS). The primary advantage to server-side scripting is the ability to highly customize the response based on the users requirements, access rights or queries into data stores. Client-side scripting generally refers to the class of computer programs on the web that are executed client-side, by the user's web browser, instead, of server-side. The type of computer programming is an important part of the Dynamic HTML concept, enabling webpages to be scripted, i.e., to have different and changing content depending on user input, environmental conditions (such as the time of day) or other variables.

PHP is a general-purpose server-side scripting language originally designed for web development to produce dynamic webpages. For this purpose, PHP code is embedded info the HTML source document and interpreted by a web server having a PHP processor module which generates the webpage document.

Service provider 56 provides the user of local component 22 with a code, such as a uniform resource indicator (URI), uniform resource locator (URL) or web address that corresponds to the uploaded content. This code or address may then be forwarded to business A's website administrator, who may insert it into one or more locations of business A's website. If the user of tool 20 is the website administrator of business A's website, then no such forwarding need take place. After the code is inserted into the desired place or places within business A's website, the website will retrieve the content corresponding to that code stored on the service provider 56's server 54 when a visitor to business A's website takes one or more specific actions (e.g. clicking on a specific link or content on a page of business A's website).

The retrieval of a webpage or portion of a webpage from service provider 56 may happen without the knowledge of a visitor to business A's website. In other words, the process may involve domain masking so that a visitor to business A's website is unaware that the content he or she may be viewing, which indicates business A's web address in his or her web browser, is actually content coming from service provider 56's server 54. As an example, suppose business A has a website at www.businessA.com, and an individual using Internet accessible computer 44 goes to this address to view business A's homepage. Further, suppose the homepage includes a hyperlink labeled “About Business A,” and this link is connected to the console stored on service provider 56's computer and created by tool 20. When the visitor clicks on this link, the visitor is taken to a new page that displays content about business A, such as, for example, one or more videos he or she may choose to play that describe different aspects of business A. In this visitor's web browser, this page is indicated as being part of business A's web address. That is, the browser may indicate this address as being at www.businessA.com/***, where “***” indicates some further information. Thus, the visitor will be unaware that be or she is viewing content that resides somewhere other than on server 42.

In accordance with the present invention, by making local component 22 simple to use, but with powerful editing and design capabilities, an individual authorized user having little or no technical skills can rapidly edit or add to business A's website. Further, once a page or a portion of a page has been designed using tool 20 and uploaded to service provider 562's server, any further changes to that page or portions of a page does not necessitate a new code, or URI, to be forwarded to business A's web administrator and integrated into business A's website. Instead, the original code, or URI that was forwarded from service provider 56 to the user of tool 20 upon the initial upload will be automatically re-linked-by remote software component 24 to the modified page. Thus, the link within business A's website to the page, portion of a page or other resources maintained at service provider 56's server 54 will persist after modifications have been made via local component 22 to the page, portion of a page or other resources maintained at server 54.

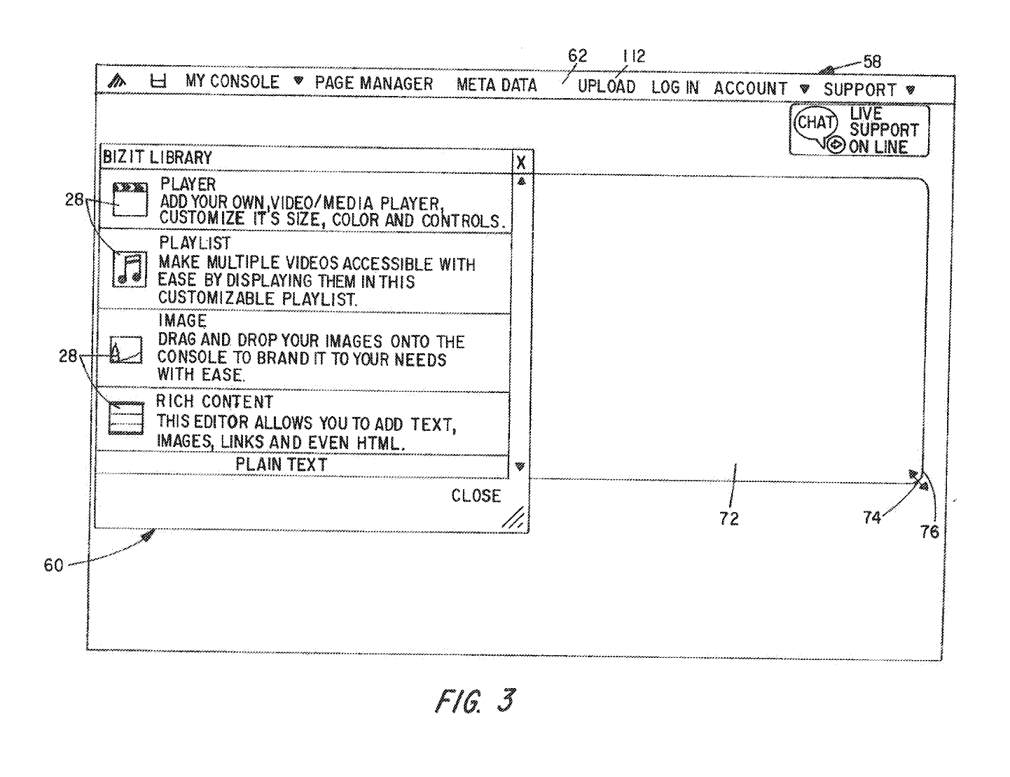

An example of a screen shot 58 that local component 22 may display on a screen 52 of a computer, such as computer 48 or 50 or another computer, can be seen in FIG. 3. Screen shot 58 includes console 26 and a widget window 60 inside of which are positioned a plurality of widgets 28. Positioned along the top edge of the screen shot is a menu bar 62 that includes various options, including a selection for editing the console, uploading video, obtaining support, saving the console, loading the console, and logging in. User interface 30 enables a user of tool 20 to interact with the elements displayed on screen 52, and in the embodiment shown, user interface 30 (FIG. 1) comprises the software that interacts with and responds to inputs from a mouse 64 and/or a keyboard 66 (FIG. 2) and/or any other physical device that may be used to control the operation of the computer.

As stated earlier, console 26 defines an area that acts essentially as a canvas upon which webpage content may be painted. That is, console 26 defines the outer boundaries of the webpage that is to be designed and uploaded. Tool 20 allows the user to change the boundaries of console 26, including both it size and shape. Such changes in size and/or shape may be accomplished by clicking mouse 64 adjacent a corner 70 of console 26 and dragging the corner to the desired location such that console 26 has the desired shape and size. Of course, other manners for resizing and/or reshaping console 26 may be implemented.

A user of tool 20 may select a background 72 for console 26. Background 72 will be the background seen by a visitor to the webpage being designed using tool 20. Tool 20 further allows the user to select and change various characteristics of background 72, such as its color, size, shape, texture or other characteristics. One manner of changing the size or shape of background 72 may involve mouse clicking on a corner 74 of background 72 and dragging it in a manner similar to console 26. A resizing arrow 76 may appear when mouse clicking at a location adjacent corner 74 in order to assist in the resizing and/or reshaping process.

Another feature of design tool 20 is the ability to position content anywhere on console 26 and have the content show up precisely on the visited webpage at the same location as the content was placed on console 26. In other words, console 26 of design tool 20 shows the user a What Yon See Is What You Get (WYSIWYG) preview of the webpage. When the design is finished, whatever content is on console 26 will appear in a visitor's web browser in the same location and with the same arrangement as it was designed on console 26. Consequently, tool 20 does not undertake any modifications of the content between the design process and the implementation process. Instead, console 26 shows the content as it will actually appear.

Still another feature of design tool 20 is the ability to position the different types of content anywhere on console 26. That is, console 26, in at least one embodiment, does not include any predefined layouts that limit where content can be placed, or the type of content that can be positioned in certain areas. Instead, console 26 of design tool 20 is a completely free-form design tool that enables the designer complete discretion in positioning any type of content at any location on console 26. However, in order to aid users in “lining up” design elements positioned on the console 26, a snap grid may be implemented such as a snap grid of 10 px by 10 px or with other dimensions. The snap grid operates in the same manner as conventional snap grids which automatically position objects so as to be aligned with an invisible grid having specified dimensions or to other objects. In some embodiments, the snap grid feature may be turned off by the user of tool 20.

In some embodiments, an enterprise user of tool 20 may use tool 20 to create one or more predefined layouts that limit how subsequent users of the tool who are associated with that enterprise may define web content. However, the enterprise user still has complete freedom in designing the layout—that is, the console 26 remains completely free form to the enterprise user. Should the enterprise user decide to create one or more layouts, such as layouts that have a specific company logo, trademarks, or other content positioned at specific locations, he or she is free to rise tool 20 to do so. Subsequent users who design content and who are associated with the enterprise may then be limited to designing content within the constraints of the layout, but their limitation is a product of the enterprise user not any inherent functional limitations of tool 20. In other words, layouts are an option, not a requirement of tool 20. In general, a layout refers to the sizing and/or placement of items within a webpage or template. A template (TPL), as used herein, generally refers to the color scheme and overall look and feel of a webpage.

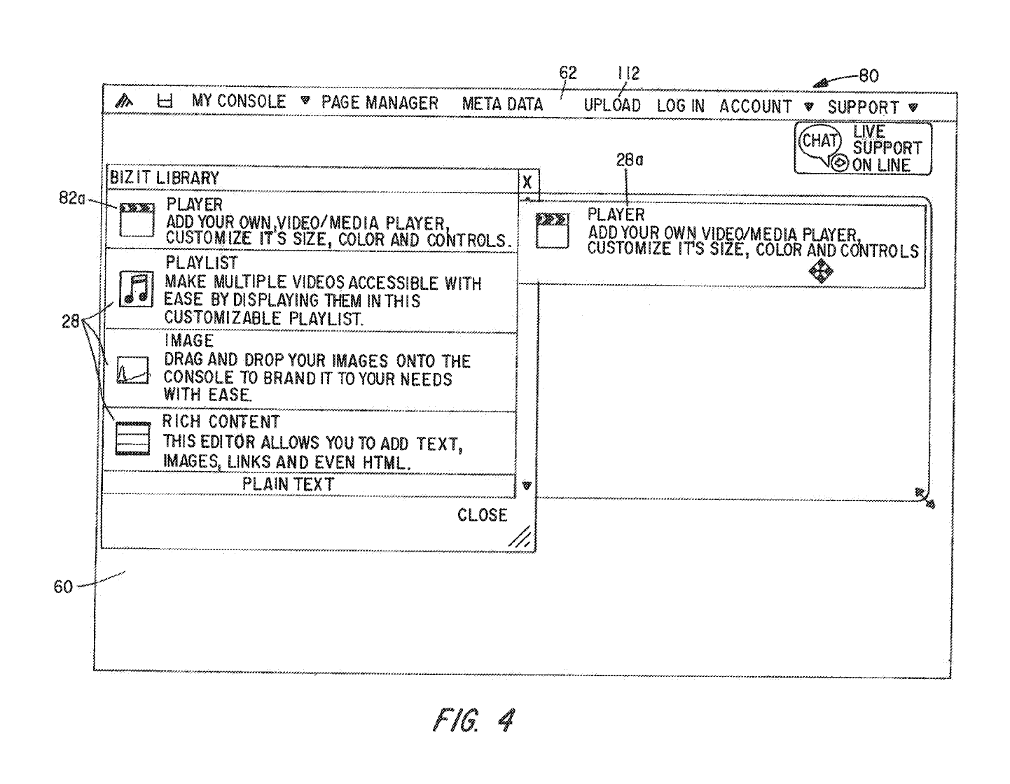

FIG. 4 illustrates another screen shot 80 of design tool 20 that shows how a player widget 28a may be dragged and dropped onto a selected area of console 26. By mouse clicking in window 60 on any location within a boundary 82 surrounding player widget 28a, a duplicate boundary 82a and copy of player widget 28a is created that may be dragged, via mouse 64, to a desired location on console 26. It will, of course, be understood by those skilled in the art that different manners of positioning a player on console 26 may be implemented besides dragging and dropping via a computer mouse. Further, it will be understood that references to “mouse clicking” herein may be carried out in a variety of known different manners—e.g. by manipulating keys on a keyboard or using a touchpad, etc.—and such references to mouse clicking herein will, therefore include these alternative actions.

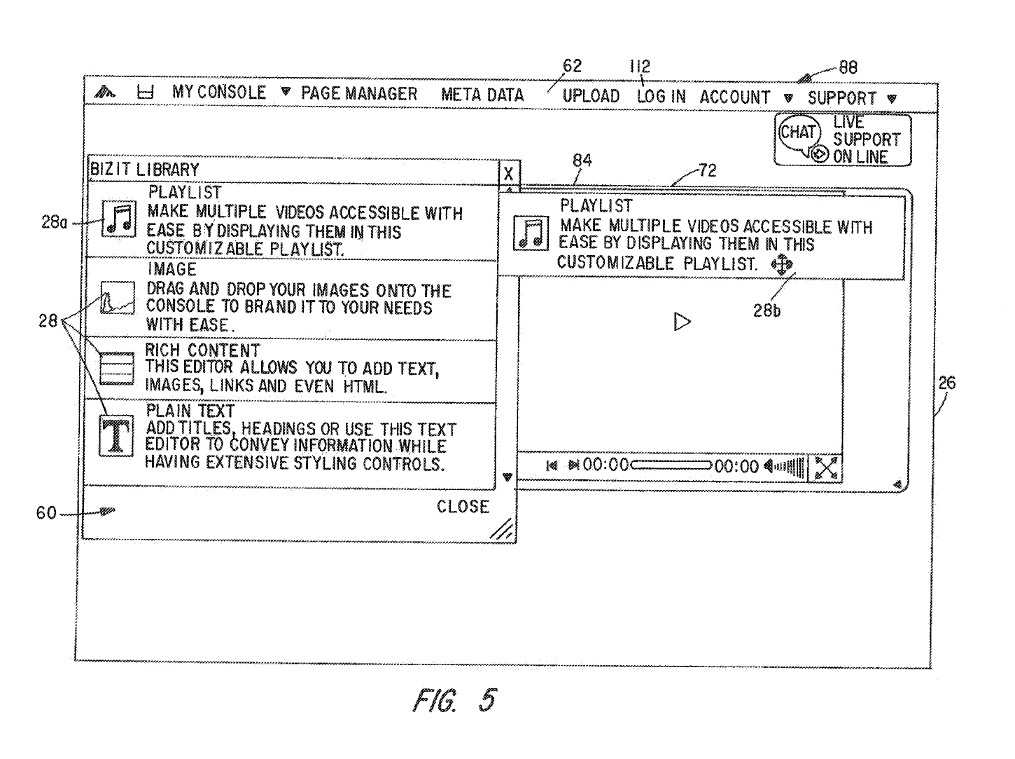

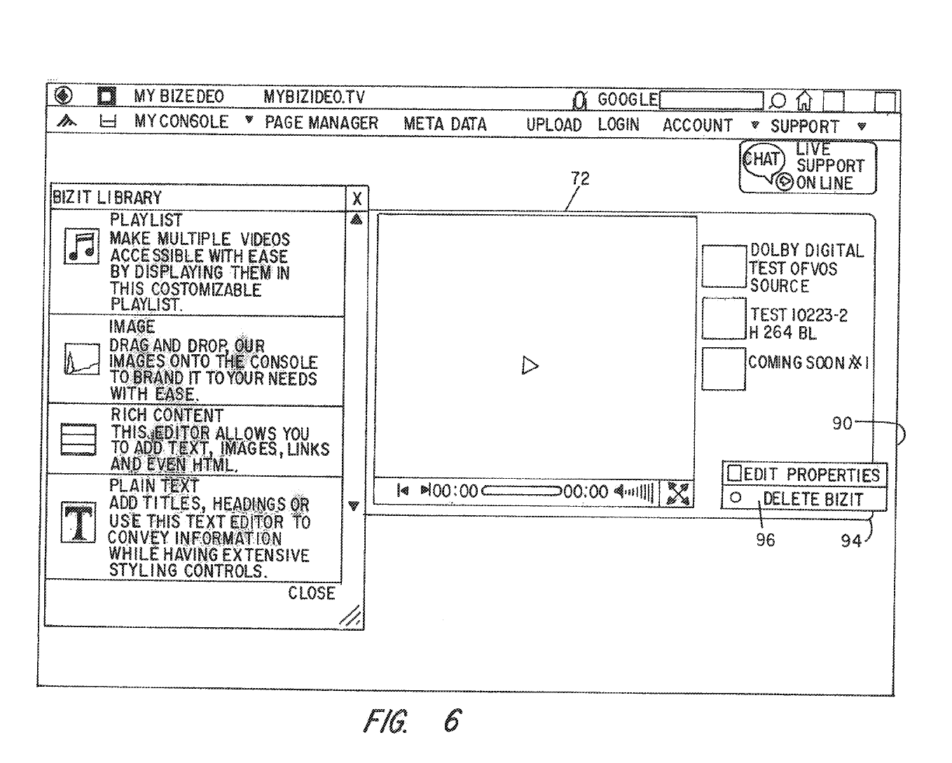

FIG. 5 illustrates a player 84 that has been inserted onto console 26 at a desired location. Player 84 is an object that enables one or more different types of media to be played on a website. Player 84 may be a player that plays video, a player that plays audio files, such as mp3 files, or any other type of devices that plays content. In one embodiment, player 84 may be an open source video player, such as the JW Player available from Long Tail Video or a Wimpy Wasp player available from Plaino, LLC, or other flash or non-flash video format players. In other embodiments, player 84 may be an Adobe Flash player or any other type of player. In still other embodiments, web design tool 20 may incorporate multiple different types of players that can be selected by the user. For example, after dragging and dropping, player 84 to the desired location on console 26 (FIG. 5), web design tool 20 may allow the user to select different properties of the player by right clicking on player 84. Such right clicking may bring up an additional window (not shown) in which various properties of player 84 are listed and which may be selected and/or changed. The list of such properties may include, for example, options for selecting the type of player (e.g. Adobe Flash video, Windows Media, Quicktime Movie or some other type of player).

Many additional properties may also be configured by the user of web design tool 20, such as by right clicking on player 84 to bring up a window of properties, or by other means. Such properties enable a user of web design tool 20 to select both the look and functionality of player 84. As some non-exhaustive examples, the user may select the size, shape, background color and texture, border, shading and other aesthetic features of the player. Further, the user may configure where and whether the player is to include the conventional play, pause and volume control icons, a visitor re-sizing option and other features. The visual appearance of these buttons, controls and options may also be changed by the user of design tool 20. Further, as noted above, the type of player may also be selected from the properties.

The screen shot 88 of FIG. 5 illustrates how the content to be played on one or more players 84 positioned on console 26 may be chosen. More specifically, FIG. 5 illustrates how a playlist widget 28b may be dragged and dropped onto any location of console 26. Such dragging and dropping may be carried out via suitable mouse actions or by other means as already explained. Once playlist widget 28b has been positioned at the desired location on the console 26, a playlist window 90 appears on console 26. This is illustrated in FIG. 6, which shows another screen shot 92. Playlist window 90 is a window that will be visible to a visitor to the webpage being designed by tool 20 and which enable the visitor to choose which video or other type of file to play on player 84.

Tool 20 enables the designer to edit various characteristics of playlist window 90, in addition to populating it with the desired list of videos, or other content, that may be played on player 84. For example, the size and shape of playlist window 90 may be changed by clicking on a corner 94 of window 90 and resizing and/or reshaping window 90 in a conventional Windows® or Mac OS or GUI (graphical user interface) manner, such as has been described above with respect to console 26 and background 72. The color, background, border, shadowing and other visual characteristics of playlist window 90 may also be edited by the user of tool 20.

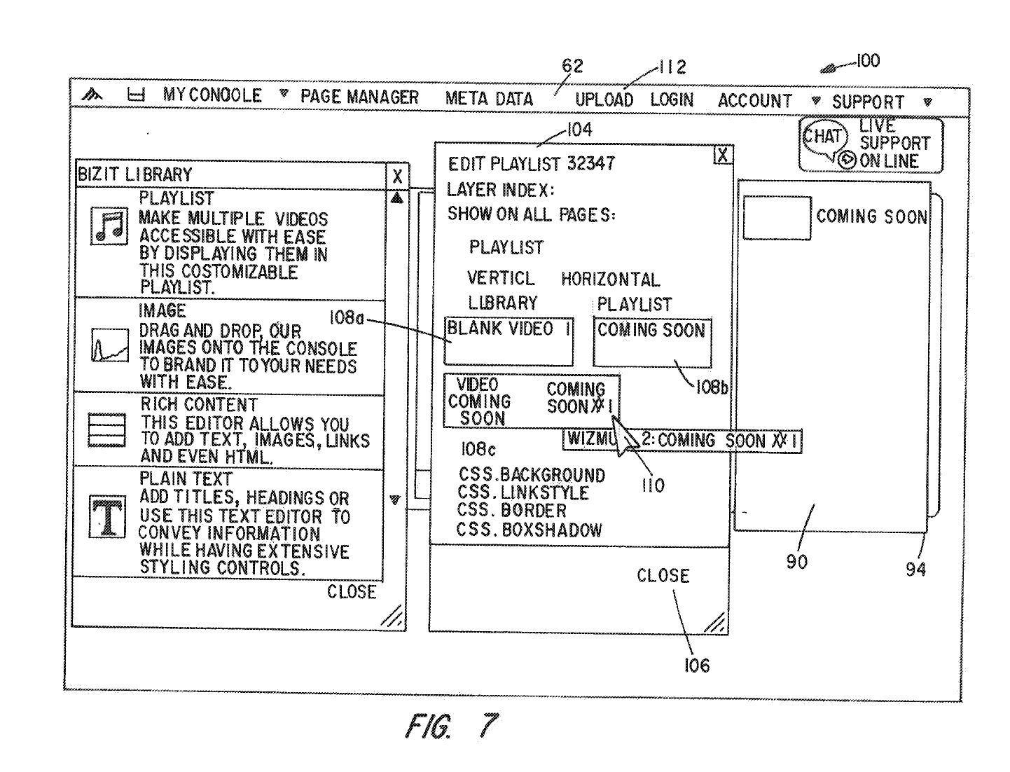

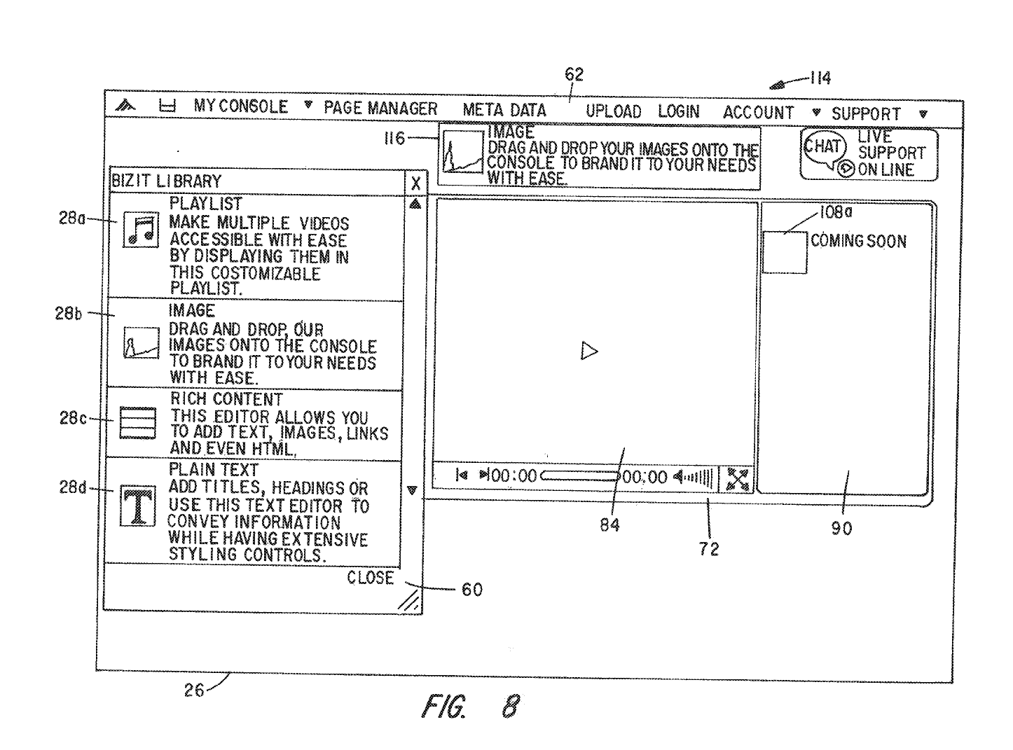

One manner of editing the properties of playlist window 90 is shown in FIGS. 6 and 7. Other manners are also possible. As can be seen in FIG. 6, a playlist options window 96 may be brought up on computer display screen 52 (FIG. 2) such as by right clicking on playlist window 90 or by other means. Playlist options window 96 includes two options: (1) editing the properties of the playlist and (2) deleting the playlist. By clicking on the “delete playlist” option (identified as “delete Bizit” in FIG. 6), playlist window 90 will be erased. By clicking on the “edit properties” option, one or more additional windows may appear that provide the user with tools for editing the properties of playlist window 90. An example of the windows that may appear in response to clicking the “edit properties” option in playlist options window 96 is shown in screen shot 100 of FIG. 7.

Screen shot 100 of FIG. 7 shows an edit playlist window 102 and a video library window 104. Both windows 102 and 104 include a “close” button 106 that may be clicked to allow the user to close these windows. Edit playlist window 102 includes a listing of available videos which a user may select from to populate playlist window 90. In the example shown in FIG. 7, edit playlist window 102 includes a first available video 108a, a second available video 108b and a third available video 108c. Any of these may be selected to populate window 90.

One manner in which such population may be accomplished is by dragging and dropping the videos 108 into the appropriate location on playlist window 90. This is shown in FIG. 7 with respect to video 108b. More specifically, video 308b is shown in FIG. 7 as having been clicked on and in the process of being dragged into playlist window 90. A hand icon 110 signifies that video 108b is currently being “grabbed” by the mouse and thus the movement of the mouse will cause corresponding movement of video 108b. Consequently, in order to insert video 108b into playlist window 90, mouse 64 may be manipulated to move video 108b into the desired location on window 90. Once in the desired location, the mouse button may be either released or clicked again In order to drop video 108b therein. The position at which video 108b is dropped will determine its order within playlist window 90.

Removing videos from playlist window 90 may be accomplished in the reverse manner. That is, any video within playlist window 90 may be removed by dragging and dropping it back into the edit playlist window 102. Alternatively, by right clicking on a video within playlist window 90 or by other means an options window may be brought up that presents the user with the option of deleting a specific video, moving a specific video or deleting and/or moving groups of specific videos.

Video library window 104 presents the user of web design tool 20 with an additional source of available videos. Transferring videos within window 104 to or from either window 90 or window 102 may be accomplished in the same drag and drop fashion discussed above. Video library window 104 may display videos that are available for insertion into playlist window 90 that are stored within a specific library of videos. The library of videos may be stored on server 54 of service provider 56 or in other locations, if stored at server 54, movement of selected videos from window 104 into 90 will cause tool 20 to populate window 90 with one or more videos which are not local to the computer on which local component 22 is running, but which are located remotely (e.g. on server 54).

Edit playlist window 102 enables a user of tool 20 to edit the order of videos in window 90 as well as to edit the display properties of the videos contained with window 102. As shown in FIG, 7, some of the properties include the background, the border and the box shadow of the videos. Other properties may also be edited via window 102, such as a specific thumbnail image to be displayed tor a video as well as other properties.

The contents of video library 104 may he created by business A, someone hired or affiliated with business A to create videos, by service provider 56 or some combination of these entities. That is, business A may hire a videographer or videography company to create one or more videos for incorporation into business A's website 40. After the videos are created, they may be converted to an electronic digital format and stored on either computer 48 or computer 50 or some other computer running local component 22 of design tool 20. Once on computer 48, 50 or some other computer, the created videos may be uploaded to service provider 56's server 54 by clicking on the upload video option 112 on menu bar 62. This option, causes the created videos to be transmitted over the Internet from computers 48, 50 or some other computer to server 54 for storage. Service provider 56 may process the uploaded videos further before making them available to the user of tool 20 via library window 104. Such processing may involve converting the video file format into a different file format, or other processing tasks.

As an alternative, service provider 56 may include a number of videos within the video library that are made available to business A upon business A paying a license, subscription or other type of fee. Still further, business A could contract with service provider 56 to create additional videos for populating the video library that is accessible to business A. The source of the videos within the video library may therefore be varied.

Web development tool 20 further enables additional properties of the videos 108 to be set by a user. For example, tool 20 enables the user to choose whether a video begins playing immediately upon a visitor coming to the webpage, or whether the video begins after a certain amount of time or whether die video begins in response to the visitor taking some action on the webpage. The type of action that may initiate the playing of the video can be varied. Further, use of the tool 20 enables the user to set video display properties that are dependent upon the particular visitor or particular class of visitor to the webpage. For example, if a visitor is visiting the designed webpage for the first time, a user of tool 20 can design the webpage so that video X plays. If the visitor has already visited the webpage, then the user could set video Y to play. Different videos could be played each time the visitor returns to the site. Determining whether a visitor is a first time visitor or a prior visitor may be accomplished by examining the “cookie” files within the visitor's web browser or by other means. The manner in which tool 20 may be used to implement any of these video rules, contingencies or properties may be carried out specifically through player widget 28a or by other means.

In addition to controlling video content based upon, whether a visitor is a first time, second time or other repeat visitor tool 20 may be used to set other video display properties that ate dependent upon other characteristics of the visitor. For example, the display of videos maybe contingent upon whether the visitor is a paid subscriber, a member of the general public, a registered visitor, upon specific sub-levels within these categories (e.g. whether a premium paid subscriber or a general paid subscriber) as well as any other type of classification system for visitors. All of these contingencies may be set by the user of tool 20 so that be or she may design content that is specifically targeted to a particular class or type of users, or in some eases, content that is specifically targeted to a particular individual. As was noted, these contingencies may be set by the user by the appropriate manipulation of player widget 28a or other means.

FIG. 8 illustrates a screen shot 114 of a console 26 upon which both a player 84 and a playlist window 90 containing three videos have been inserted. Further, screen shot 114 illustrates how images may be inserted onto console 26 by use of an image widget 28c. Image widget 28c, like all of the widgets 28, enables a user to place content at a desired location by dragging and dropping the widgets 28c to a desired location on console 26. In this ease, the content that may be positioned on console 26 by widget 28c is images.

In FIG. 8, an image 116 (a company logo) has been dragged and dropped info place just above player 84. The image is titled in FIG. 8 as “generic logo company,” but this is merely illustrative. Any type of image may be inserted onto console 26, not just business logos. Such images may be in any conventional image file format, such as JPEGs, bitmaps, TIFFs, PDFs and still others. The images may reside on the computer upon which local component 22 is operating—e.g. computer 48 or 50—or it may reside elsewhere at any location accessible to that computer. Tool 20 enables the user to modify and edit the content of the image. For example, widget 28c may enable cropping, rotating, resizing, reshaping, relabeling and other editing of the image 116.

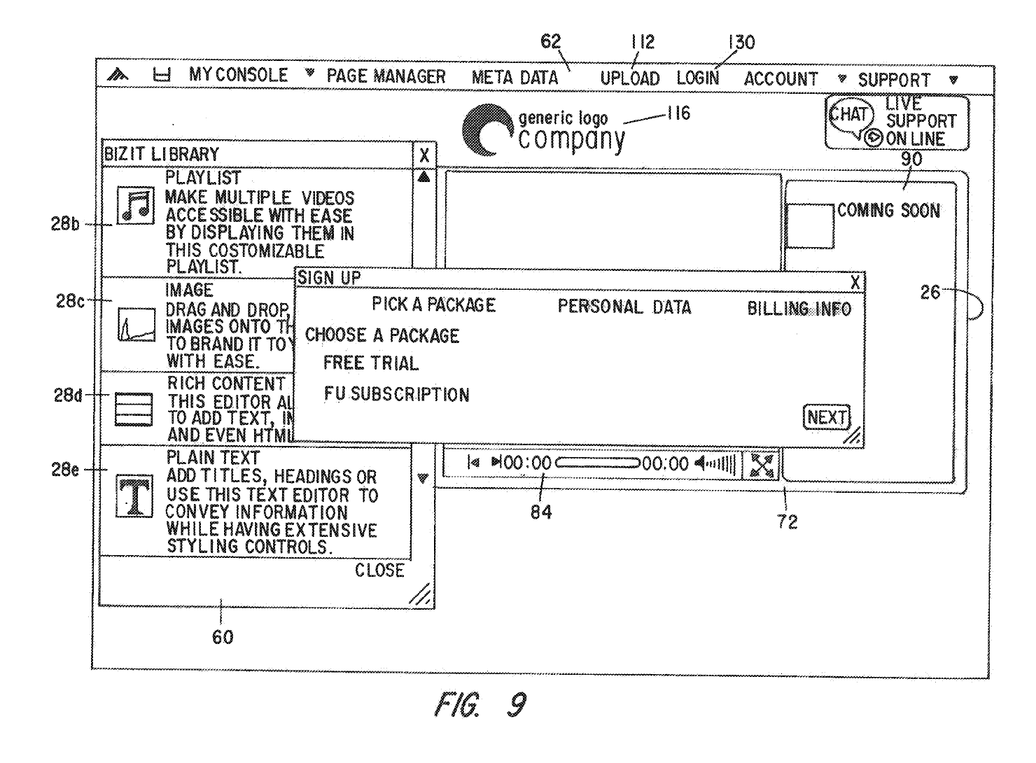

As used herein, rich content is information that may provide value for an end-user/audience in specific texts such as when video is embedded with text. FIG. 9 shows a screen shot 120 that illustrates the use of a rich content design widget 28d. Rich content design widget 28d allows rich content to be inserted onto console 26 at any desired location in a drag and drop manner. In the example shown in FIG. 9, widget 28d has been used to insert some rich content text 122 inside of playlist window 90. Specifically, widget 28d has been used to insert the phrase “More Info” at the bottom of play list window 90. By right clicking on the rich text 122 and/or widget 28d, the properties of the rich content may be displayed. In a separate window (not shown) front which the user may alter the properties as desired. In the example shown in FIG. 9, clicking on rich text 122 may bring up the properties such, as color, font, font size, shadow, orientation, text effects and the like. Other rich content may be added via widget 28d besides text. The properties list corresponding to the other types of rich content may differ depending upon the specific type of rich content that is added. As with all of the widgets 28, rich content widget 284 enables rich content to be placed at any location on console 26 rather than in specific predefined templates or fields, thereby giving the user a free form for creating a webpage.

In the example of FIG. 9, design tool 20 also includes a plain text design widget 28e. As with all of the other widgets, plain text design widget 28e allows content to he inserted onto console 26 at any desired location through a drag and drop method. In this specific case, widget 28e enables plain text to be Inserted at any location on console 26. Thus, a user of tool 20 may insert plain text wherever he or she wants to when designing a webpage using design tool 20. By right-clicking an the inserted plain text, or through other means, a list of properties for the plain text may be displayed In a window (not shown), or in another manner. Each of the listed properties may be changed as desired by selecting the property and changing the property through any suitable means.

While not illustrated in the illustrative screen shots of FIGS. 3-9, design tool 20 may include additional widgets 28 beyond those shown in these drawings. Further, it will be understood that design tool 20 need not necessarily include the specific widgets shown in FIGS. 3-9. That is, the choice of which specific widgets 28 to Include in design tool 20 may be varied from, one embodiment to another.

In at least one embodiment, additional widgets 28 are included that enable a user of design tool 20 to insert web application programming interlaces (APIs). Such widgets may work in the same drag and drop manner as has been described above with respect to widgets 28a-28e. Further, such widgets may be positioned on console 26 at any desired location. In some embodiments, one widget 28 may allow for the insertion of a plurality of different types of web APIs. In other embodiments, each API or type of API may have a separate widget associated therewith.

While the number and type of web APIs that may be inserted onto console 26 is not limited, it may be helpful to describe a few examples. Design tool 20 may be constructed to include a mapping API widget that enables the user to insert a mapping function from another web resource. As an example, an API widget corresponding to Google Maps, Yahoo Maps, Mapquest, or some other on-line mapping service may be incorporated into design tool 20. Such widgets may be useful for a variety of different types of webpages. If business A is a realty business, such mapping APIs may desirably be included on a webpage to enable the visitor to the webpage to see a map corresponding to one or more specific pieces of real estate. If business A is a restaurant, or other type of retail establishment, such APIs may be desirably included on a webpage to allow potential customers to find the physical location of the retail establishment, or the location of branches or satellite offices associated with the retail establishment.

Such mapping API widgets may be clicked on, or otherwise manipulated, to enable the user of tool 20 to change the properties of the mapping API. Thus, for example, the size of the window in which the map is displayed may he adjusted. Whether the map displays satellite views only, or map views only, or a combination of satellite and map views only may be set by the user of tool 20. Still further, the user may choose what the initial address will he that will be displayed in the map window, as well as the zoom level. Any other properties associated with that particular mapping API may also be selected via design tool 20.

In addition to mapping API widgets, tool 20 may also include API widgets for inserting financial transaction APIs, such as, for example, an API for PayPal, or a credit card processing API. Such APIs enable the user of tool 20 to easily design a webpage that calls for visitors to make a payment through the webpage, whether via a PayPal account, a credit card, or some other type of financial transaction. Such payments may be for products or services offered by business A, or for any other reason.

Tool 20 may further include API widgets that interface with social-networking sites, (such as Facebook, My space, LinkedIn, or the like), weather APIs (that display radar or weather images, or that display temperatures and weather conditions at one or more locations, or other weather information providing APIs), Twitter APIs, or any other type of web API that may desirably be inserted onto a webpage.

In addition to web API widgets, tool 20 may include still other widgets for assisting in the design of a webpage. Such widgets may include timing widgets that enable a user to set viewing rules or viewing conditions that are time-based. These rules may be applied to any or ail of the content laid out on console 26. The-time-based rules may be based upon the time of day, the time of week, the time of month, the time of year (e.g. seasons), or any other time based criteria.

For example, the content designed on console 26 may include videos, or other information, that may desirably only be presented to its website visitors during certain seasons. As but one example, suppose business A is a retail business that sells, among other things, outdoor Christmas lights. Web tool 20 could be used to design a page that displays a video explaining techniques for stringing up Christmas lights to a person's house wherein the video only appears on the page during the Christmas season. The rules for when this video, or a class of Christmas-related videos, or other seasonal items, may ail be set using tool 20. Other types of timing contingencies may also be incorporated into the design of console 26 using tool 20.

In another embodiment, the timing widgets may alternatively be incorporated into tool 20 as properties of the various other widgets 28, rather than as separate widgets themselves. In other words, clicking on a particular widget 28, or the content created by a particular widget, could bring up a list of properties that includes “rules” property, a “timing” property, or the like. By selecting the “rules” property or “timing” property, the display of that particular piece of content could be controlled in some time-based fashion. Such time based properties could be incorporated into any of the design, widgets 28, including, but not limited to, player widget 28a, playlist widget 28b, image widget 28c, rich content widget 28d, and plain text widget 28e, as well as any of the web API widgets, or any other widgets that axe incorporated, into tool 20.

Another design widget 28 that may be incorporated into any one or more embodiments to tool 20 is a document widget that enables documents to be uploaded to the webpage being designed. The documents for uploading may be in the form of Portable Document Formats (PDFs), Microsoft Word documents, other word processing documents, spreadsheets and/or many other types of documents. Such a document widget could allow edits to be made to the uploaded document via the rich content widget 28d or by other means. In some embodiments, the functions of the document widget and the rich content widget 28d could be partially or wholly combined. In still other embodiments, any of the widgets discussed herein could be either partially or wholly combined with any one of more of the other widgets discussed herein.

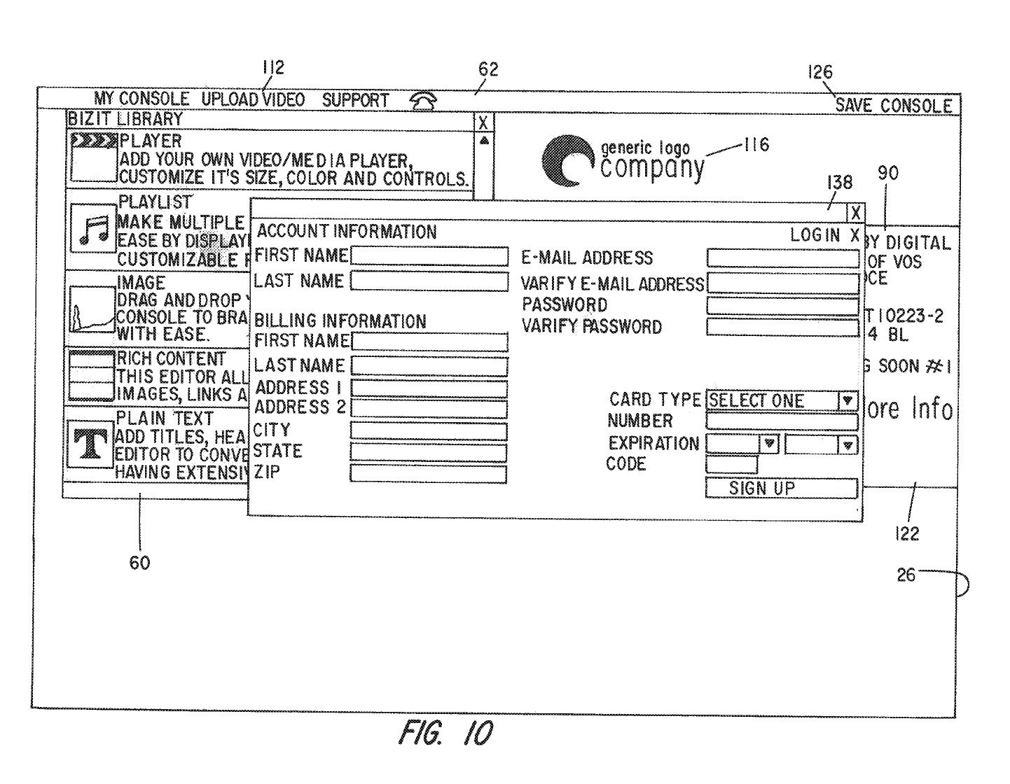

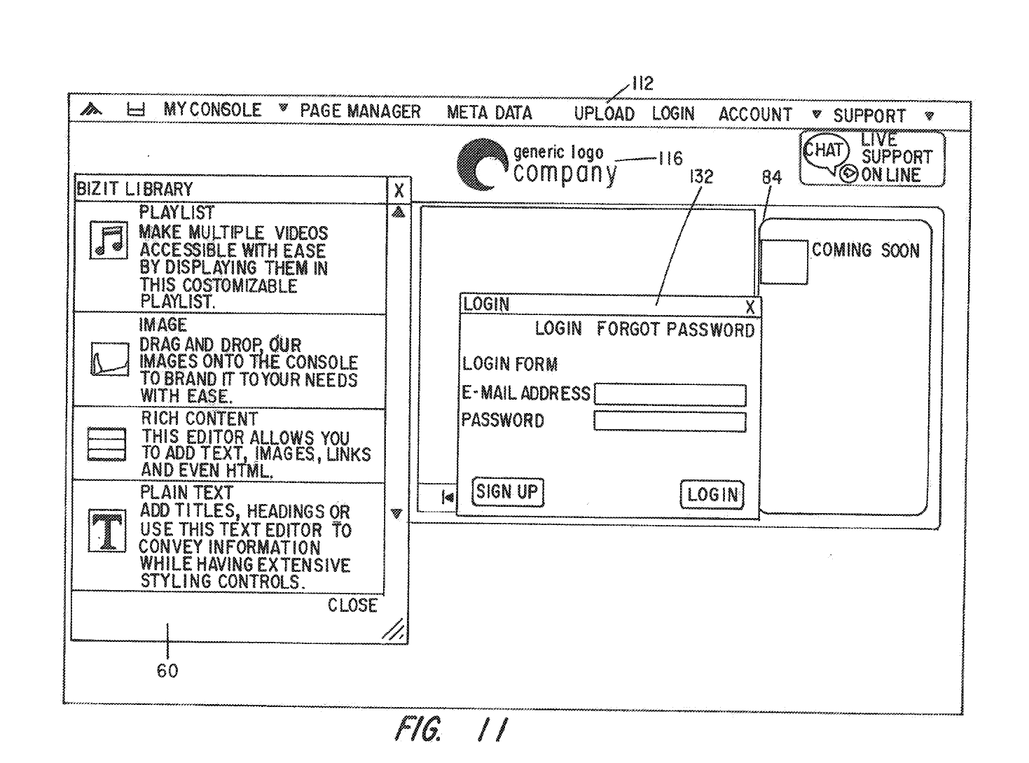

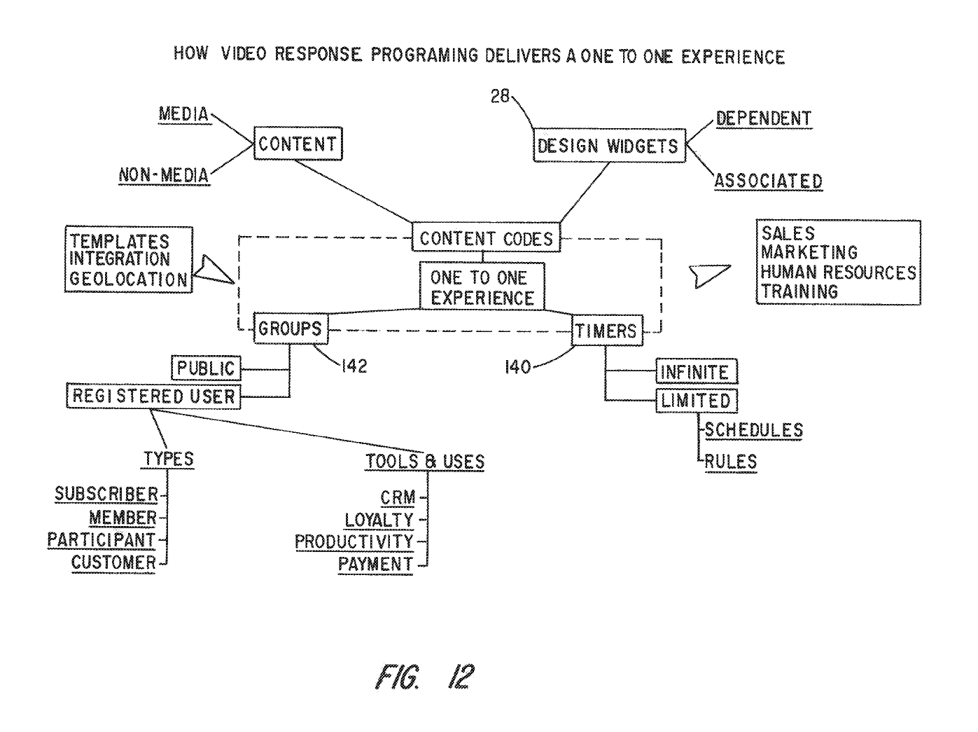

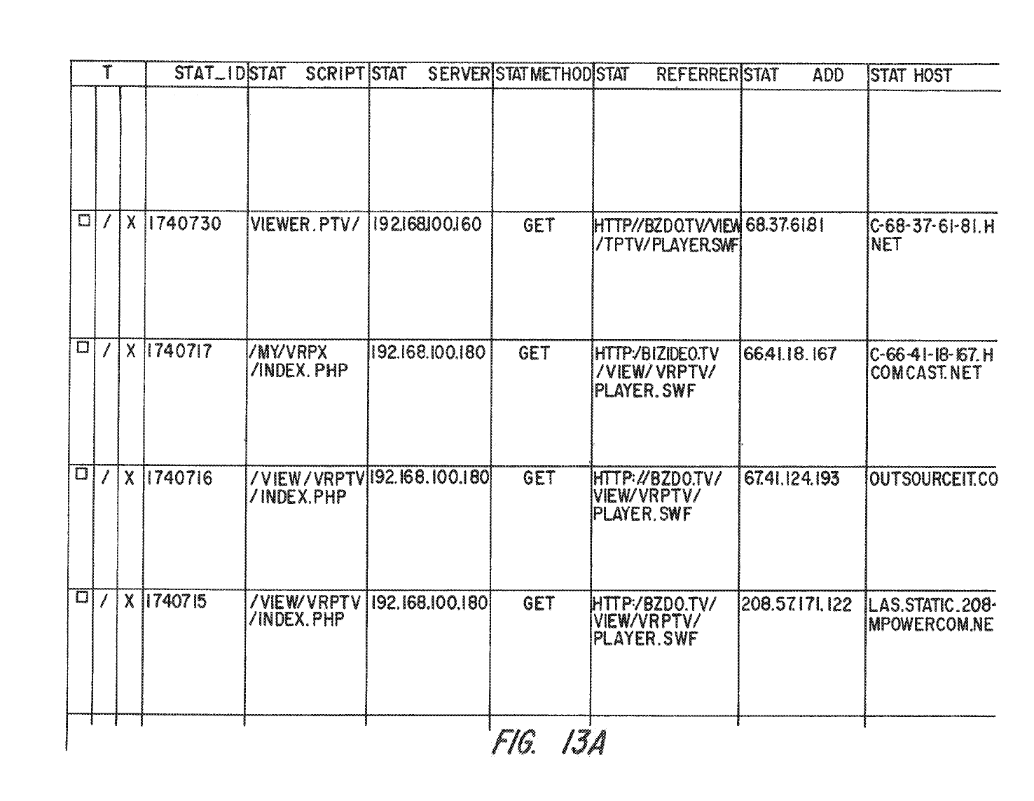

At any time during the use of tool 20, the user may save his or her console by clicking on the save console option 126 on menu bar 62 (see FIGS. 9 and 10). Activating option 126 will cause the current configuration of console 26 to be saved remotely at server 54 of service provider 56. Further changes or additions may then he made in the future to the saved console by clicking on the load console option 128 (FIG. 9) and loading a previously saved console configuration. In order to load consoles from server 54, a user may need to first login in order to be granted access to server 54. Such access may be obtained by clicking on login option 130 (FIG. 9).

If a user of tool 20 is using tool 20 for the first time and has not established an account with service provider 54, clicking on the save console option 126 may first bring up an account and payment window 138, such as is shown in FIG. 10. Account and payment window 138 provides data fields for the user to enter a name, email address, password, and similar data to establish an account with service provider 56. Account and payment window 138 further includes data fields for inputting billing information such that one or more payments may be transmitted to service provider 50. Once the necessary information has been input into account and payment window 138, the user will be able to save on server 54 the contents of the webpage he or she designed using his or her local computer (e.g. computer 48, 50, or another computer). While account and payment window 138 is shown in FIG. 10 as lying within console 26 and being positioned on top of player 84, background 72, and a portion of playlist window 90, it will be understood that window 138 is not part of the design of console 26. That is, the webpage that is finally designed by the user of tool 20 will not include window 138. Rather, a visitor to a page of business A's website that was linked at the webpage stored on server 54 (and created using tool 20) will never see window 138. Instead, the visitor will only see the content that has been placed on console 26 by one or more of the widgets 28. Window 138 will only be visible to the user of tool 20 during the initial registration and payment process between tool 20 user and service provider 50.

As was noted above, once payment has been received by service provider 54 and a designed console saved to server 54, a user of tool 20 may later access the saved console for further editing by clicking on the login option 130. FIG. 11 shows on illustrative example of a login window 132 that may be displayed on screen 52 in response to a user clicking on login option 130. After the user enters the email, address of a user who has previously registered with service provider 56, as well as the correct corresponding password, the user will be granted access to any and all previously saved consoles corresponding to that particular account. The user may then use tool 20 to make modifications to the console.

As was noted above, after a user of design tool 20 has saved a console 26 to server 54 of service provider 56 and/or published the console 26 such that is made publicly available by service provider 56 through server 54, service provider 56 will communicate an address or link to the user of tool 20. Such communication may happen automatically via remote component 24 of tool 20 electronically sending the link over the Internet to the user of design tool 20's computer (e.g. computer 48 or 50) or it may happen in other manners. In one embodiment, the link sent by service provider 56 to the user may take on the form of a code having a predefined number of digits that corresponds to business A, followed by the web address of service provider 56. For example, after an authorized representative of business A has saved a console 26 to server 54, service provides 56 may forward a link to that console that takes the form of “BusA100.serviceprovider56.tv”; or BusA100.serviceprovider56.com”, or some other similar type of form. In either of these specific examples, the “BusA” digits identify a code that is unique to business A, while the following three digits (e.g. “100”) identify a specific class or type of content that is shown on the page created by tool 20. In other embodiments, each user of tool 20 may be represented by a three character code instead of a four character code or by a code having lesser or greater numbers of characters.

As was also noted, above, once a user of tool 20 receives the address or link to the page created on tool 20, he or she may either incorporate that link into website 40 at the desired locations, or have the web administrator of business A's website 40 do so. Once it is incorporated, any visitor on the Internet who has access to website 40—such as, for example, a visitor using computer 44 in FIG. 2—will see the content of console 26 displayed on their screen when they visit the appropriate portion of website 40, or take the appropriate actions on website 40 that trigger the display of the content of console 26. To the visitor, the display of this content will be hidden such that he or she sees the content as coming from business A's website, rather than from server 54. What the visitor will see on his or her web browser is an image of the precise content that was inserted onto console 26 during the webpage design process that utilized tool 20. In other words, the content of console 26 is converted to a viewable webpage by tool 20 operating in conjunction with service provider 54, and the viewable webpage exactly matches the layout that was designed on console 26 using tool 20. Further, the viewable webpage includes all of the functionality that was built using tool 20, including any players, playlists, web APIs, rules configurations, or other settings that were constructed with tool 20.

Service provider 56 is able to distribute multiple copies of tool 20 to multiple different users. Such distribution can be via different channels, including distribution via downloading from service provider 56's website (not shown), email, snail mail, or via other means. Server 54, or some other server or collection of servers, may therefore end up storing multiple different webpages and content from multiple different customers. In order to better manage the content and to enable the customers greater flexibility in editing and managing their own content, service provider 56 may incorporate one or more content coding or identification methods.

One content coding convention may be the assignment of a specific Uniform Resource Indicator (URI) to each video that a particular customer of service provider 56 stores on server 54. The specific URI can take on a variety of different forms, and also can have a variety of different lengths. However, in at least one embodiment, a ten character URI or content code may be used that is divided into specific segments. The specific segments may include a customer identifier, a class of content identifier, a format identifier, and a number unique to a specific piece of content (e.g. a serial number). While the size of these segments may vary, in at least one embodiment, the first three characters may identify the customer, the second three characters may identify the class of content, the seventh character may identify a format, and the final three characters may identify a unique piece of content.

Thus, for example, in at least one embodiment, the code BSA100A113 might be associated with a specific video that is associate with business A (who is a customer of service provider 56). The letters “BSA” would identify the customer as business A. The fourth through sixth characters (“100”) would identify a specific class or type of video. The specific type of class may be varied widely and may be specifically based upon the type of business that business A was engaged in. Thus, different business customers of service provider 56 may have different types of classes of videos, depending upon what line of work they are in. The seventh character (“A”) identifies the format of the video, e.g. whether the video is a Flash video or mobile friendly or any other type of specific format. The final three characters (“113”) uniquely identify a specific video.

To better illustrate the functionality of the content codes that may be used by service provider 56 in conjunction with tool 20, FIG. 8 may be consulted for an illustrative example. In the console 26 shown in FIG. 8, three videos 108a-c are shown on playlist window 90. After console 26 has been uploaded and saved to service provider 56's system, such as server 54, service provider 56 may assign a specific content code to each of videos 108a-c. As but one example, service provider 56 may assign to video 108a the code BSA100A222 to video 108b the code BSA100A225, and to video 108c the code BSA100A229. A link to any of these videos may then be easily implemented. For example, if a customer or visitor wanted to forward video 108a to a particular individual, he or she may forward a specific link to video 108a. that might take on any of the following three formats or variations thereof. A first format might be “BSA100.serviceprovider56.tv/?channel=BSA100A2222”. A second format might be “BSA100.serviceprovider56.tv/BSA100A222,” or a third possible format might be “BSA100A222.serviceprovider56.tv”. Still other formats are possible.

In any of the content codes discussed above, each character may be an alphanumeric character. That is, each character may be one of twenty-six different letters often different numbers, and in some cases, allowed special characters, such as “+”, “−” or “_”. In some instances, each letter may be case sensitive so that there is little likelihood of service provider 56 being unduly constrained within the different segments of the content code. For example, using three characters to identify a specific customer would give service provider 56 the ability to uniquely identify over 46,000 different customers (10 numbers+26 letters=36 characters, which yields over 46,000 unique codes). If case sensitivity is taken into account, then over 238,000 different customers may be uniquely identified, which should be sufficient for most any service provider 56. Further, if case sensitivity is taken into account, service provider 56 will be able to uniquely identify over 238,000 different pieces of specific content via the last three numbers of the content code.

When service provider 56 assigns a specific content code to a specific video, or other piece of content, service provider 56 wall make this content code available to the user of tool 20. However, service provider 56, in at least one embodiment, may also assign a second content code to the same video, or other piece of content, that is not made available to the user of tool 20, but instead is kept internally and confidentially within service provider 56's organization. There may, therefore, be both, a public content code (available to the user of tool 20) and a private content code assigned to each video, or to each other piece of content that is created on console 26.

The use of private and public content codes may help to alleviate any link rot on the webpages designed using web tool 20. For example, if a user of tool 20 creates multiple pages using tool 20 that all include a specific video, and user 20 later makes changes to that specific video, or replaces that specific video with an updated or corrected replacement video, tool 20 will automatically update all of the other pages that link to the specific video so that they include a link to the edited video or the new replacement video. This may be better illustrated with respect to the screen shot example of FIG. 8.

Suppose, for purposes of discussion, that a user of web design tool 20 wants to replace video 108c with a new video. This can be accomplished by logging on to server 54 (such as via the login screen shown in FIG. 11), and uploading the new video after clicking on upload video option 112 in the menu bar 62. After the new video has been uploaded to service provider 56's system (e.g. server 54), the user may view the previously saved console that includes the content shown in FIG. 8, and then right click on video 108c or take some other action with respect to video 108c that displays options for editing and/or replacing video 108c. Such actions may bring up the edit playlist window 102 of FIG. 7 and/or the video library 104 window of FIG. 7 or some other windows. Regardless of the specific window or windows that are displayed, the user will be presented with the option of choosing whether to have the new video assigned the old content code of video 108c or to have it assigned a new code. If it is assigned a new code, then the user may drag and drop old video 108c back info the video library or otherwise delete it from playlist window 90. If any other pages link to video 108c, they will maintain their link thereto and will be unaffected by the removal of video 108c.

However, if the user of tool 20 wants to replace all copies of video 108c on all pages that make reference thereto, he or she can elect to have the new video be assigned the old content code that was previously assigned to video 108c. Thus, in the example discussed above, the new video could be assigned the code “BSA100A229.” When doing this, all pages that include video 108c are automatically updated such that the old video 108c is replaced by the new video. Thus, for example, any playlists on any other pages designed with tool 20 that had previously contained video 108c will now contain the new video. Links to the new video will therefore be implemented automatically so that each and every page that had previously contained video 108c does not need to be manually and/or individually updated. This eliminates the time consuming process of prior art systems in which every page that linked to a particular video had to be updated when that particular video was replaced or otherwise changed. With web development tool 20, only a single page needs to be updated and all other pages linking to that video will be automatically updated.

The automatic updating of links to a modified or replaced video is facilitated through the use of the private and public codes mentioned above. If a user wants the new video to replace all instances of the old video automatically, then service provider 54 may simply change the private content code that previously was associated with the public content code of the old video to be associated with the public content code of the new video. In such a situation, ail pages that reference the private public code are automatically updated to be associated with the new video.

In contrast, if the user wants to replace the old video on only one specific page with the new video, but keep all the old videos that appear on other pages, then service provider 50 will keep the public content code and private content code of the new video associated with each other. The effect will be that only the selected specific page that includes the old video will be updated with the new video, while any other pages that include the old video will remain the same.

Service provider 56 may also use abbreviated content codes, or shortened versions of the content codes as keys that represent an advanced control or stewardship relationship over features, content, layout or integration for a user, a group or a channel. In at least one embodiment, a content key is made to include a subset of the content codes, such as, for example, the first six characters of the content code. Thus, in the example above where video 108a was assigned die content code “BSA100A222”, the content key for this code might be shortened to “BSA100”. This content key may be used to categorize different classes of videos and may be used in tool 20 to enable a user to design webpages that have video content which is responsive to different classes or categories of visitors.

An example may help illustrate this point further. Suppose, for example, that business A has three main types of customers, and that business A wants its website to include videos that are specifically targeted to these three different classes of customers. A user of tool 20 is able to designate certain videos as being appropriate for each class of customer, and each class of videos may be assigned a separate content code key. For example, videos appropriate for class 1 customers may have a content key of BSA101 while videos appropriate for class 2 customers may have a content key of BSA102 and videos appropriate for class 3 may have a content key of BSA103. The user of tool 20 can use these key codes to facilitate the design of various webpages that are unique to each class. For example, the user can create rules using tool 20 that limit a particular visitor to seeing only videos that are appropriate to that visitor's class. The determination of the visitor's class may be based upon information gathered from the cookies within the visitor's web browser, from information contained with the IP address of the visitor, from information about the visitor's prior viewing history of business A's website (which may be gathered and updated continuously by service provider 56), from information that the visitor has voluntarily submitted through business A's website or from any combination of these sources, or from still other sources.

Tool 20 is further designed so that the user may easily view different pages designed for specific classes of visitors without having to “log in” to each page under a different class. In other words, in the example above, tool 20 enables a user to view the different content assigned to class 1 customers, class 2 customers, and class 3 customers without having to take specific and time-consuming action in which he or she mimics the characteristics of these classes. Instead, the user may simply be presented with a window, or other means, that enables him or her to select the various classes of visitors and, upon selecting the desired class, tool 20 will automatically display the console 20 that corresponds to the selected class of visitors.

When tool 20 displays the console 26 on screen 52 of local computer 48 or 50, the user of tool 20 may have to activate a “preview” button or take other action in order for tool 20 to display console 20 on the entire screen 52. Such previewing may have one or more different levels, For example, in one embodiment the previewing only displays a rendering of the console 26's Document Object Module (DOM) as expected but does not include the ability for the user of tool 20 interact with the function content that was input into console 26 until the console is published. Alternatively, the previewing may include not only a rendering of the designed content but also include full functionality of all of the content designed or developed using tool 20 such that the user can internet with the content in the same manner as a visitor and test to determine if it operates in the desired manner. Such full functionality previewing may be performed without necessarily having the console published, in still other embodiments, more than one of these various alternatives or still other alternatives may be incorporated together into tool 20

FIG. 12 illustrates in conceptual format some of the capability of design tool 20 in delivering personalized, or nearly personalized, content to a visitor of a website that incorporate pages created by tool 20. As shown therein and as discussed above, tool 20 may be used to create content codes for both media and non-media content, as well as the content created using the design widget discussed above. The contents created by the design widgets 28 may be associated or dependent, meaning the content may be associated with other content, users, types of user, or other data, and the content may dependent upon, other content, users, types of users, or other data. Still further, as shown in FIG. 12 and discussed above, timers 140 may be incorporated into a webpage using tool 20. Such timers 140 may be based upon schedules or rules or some combination of the two. Timers 140 enable content to be delivered that is in at least some fashion contingent upon time, whether the time is measured in seconds, minutes, hours, days, weeks, months, years, or in other units.

FIG. 12 further shows that tool 20 may be used to account for different groups 142. Such groups may be defined in a variety of different manners, as shown in FIG. 12. Other manners may also be defined. Tool 20 may display different content depending upon which group a particular visitor is part of.

FIG. 12 also illustrates how tool 20 may be used with layouts that may be defined by an authorized, representative of an enterprise user of tool 20, or in other manners. Geolocation and integration may also be incorporated into design tool 20 so that the webpages designed on tool 20 are highly individualized to the specific visitor. Indeed, tool 20 in some embodiments may include sufficient features to enable a one-to-one experience to be created on the webpages so that a first visitor to business A's website, for example, will view content that is in some fashion unique to that first visitor while a second visitor to business A's website will view content that is in some fashion unique to the second visitor. The uniqueness does not necessarily mean that each piece of information displayed to the visitor will be different from any other visitor but rather that some part of the layout or some part of the aesthetics or some part of the content will be different for each visitor.

Tool 20 may thus he used to generate nearly one-to-one experiences for web visitors. Such individualized experiences may provide useful for a variety of different business and in a variety of different applications. Such individualized experiences may be particularly useful for sales, marketing, human resources, training, or in still other areas.

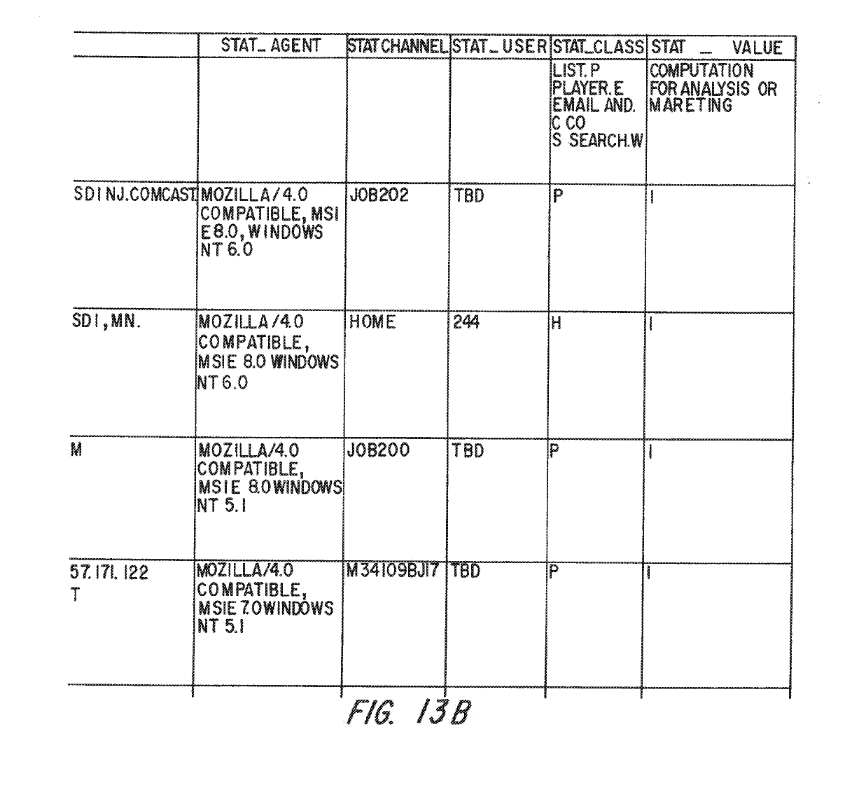

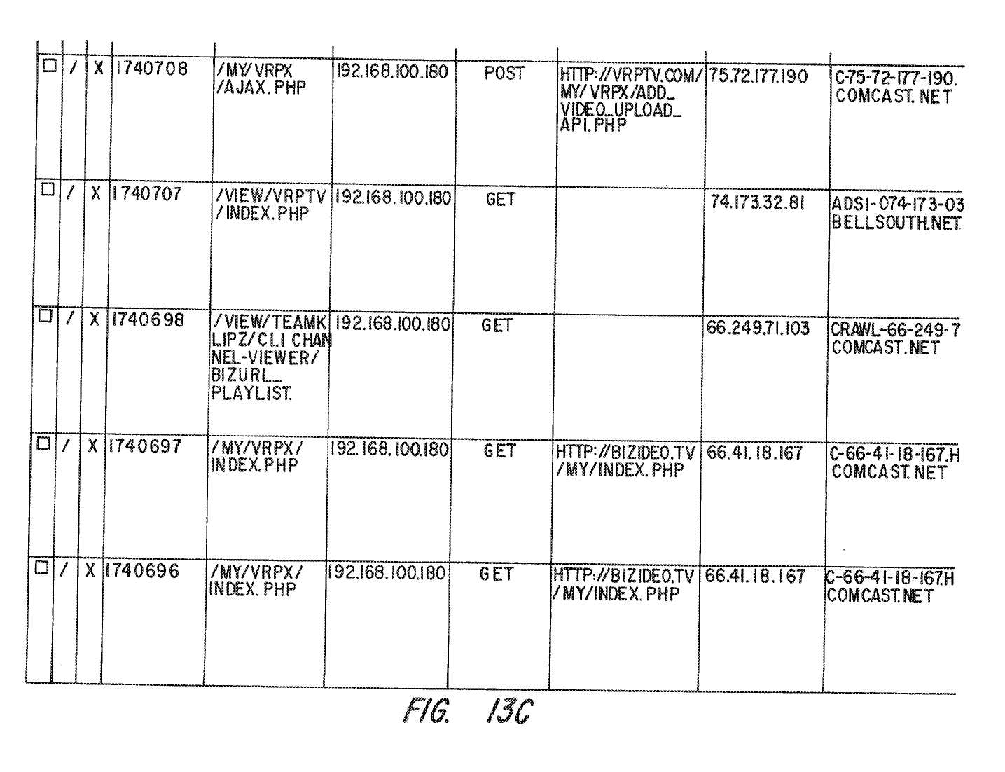

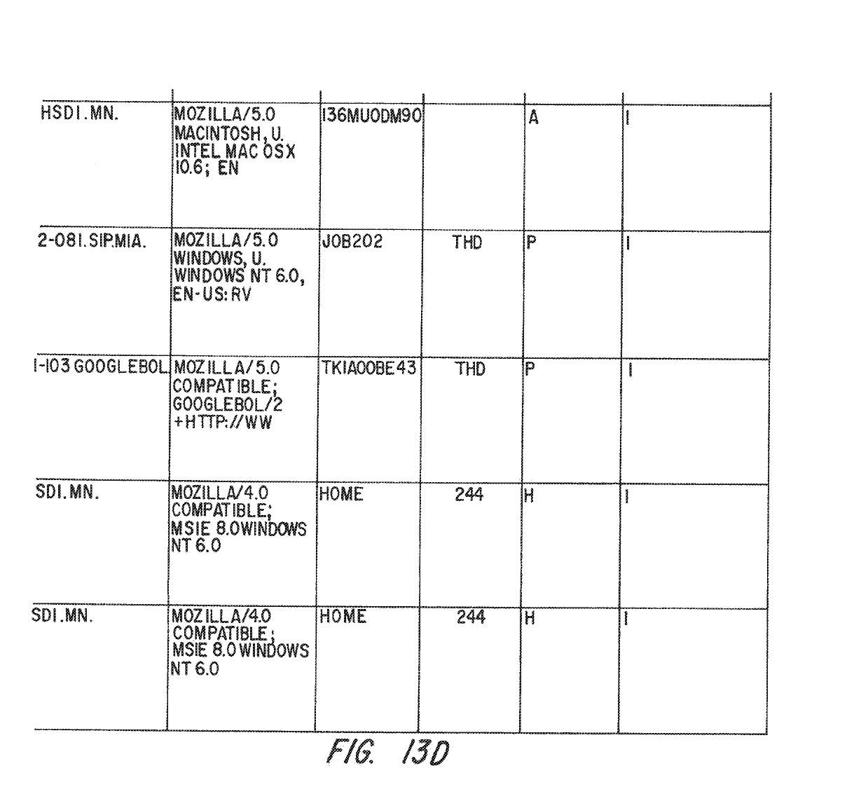

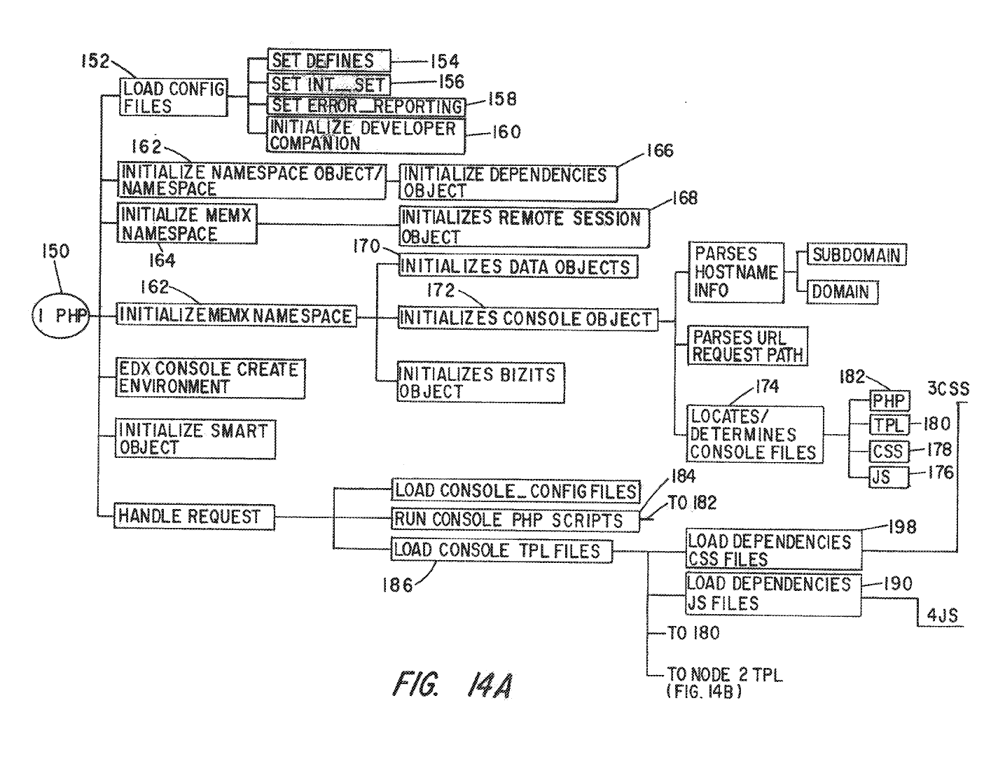

FIG. 13 illustrates a chart of data that may be gathered by service provider 50 about visitors to the webpages it maintains for its customers. For example, each time a visitor views website 40 and activates a link that brings up content from server 54, service provider 56 may gather data about that visitor. FIG. 13 illustrates the type of data that may be gathered during the visitor's visit to these webpages. Each row in FIG. 13 represents a different visitor. Each column represent different data that is gathered during the visitor's visit.

The column labeled “stat_channel” indicates the content key of the content that presented to the visitor. Thus, for example, if a visitor had visited a webpage such as that shown in FIG. 8, the “stat_channel” would include the content key “BSA100” because that content key corresponds to the class of videos within the playlist window 90. The “stat_class” column provides additional information about the particular visitor or event such as whether the visitor played a video, only viewed a homepage or took other actions.

The information that is gathered by service provider 56 may be used in conjunction with design toot 20 so that the user of the tool may take this information into account when modifying or designing webpages using tool 20. For example, tool 20 may be used to design a webpage that includes a playlist of videos that doesn't change until a visitor has watched all of the videos in the playlist. The information gathered by service provider 56 will track specific IP addresses and other characteristics about a particular visitor. When service provider 56 determines that the same visitor has viewed all of the videos on a particular page, it will automatically direct the visitor to another page (as configured by the user of tool 20) having a different set of visitors. The user of tool 20 can therefore design webpages that are contingent upon specific statistics gathered from individual users. The user sets whatever rules he or she wants implemented using tool 20. Service provider 56 then accepts those rules and delivers to the visitor whatever content is dictated by those rules based upon the visitor's visitation statistics, as well as any other information that, is incorporated into the rules dictated by the user to design tool 20.

When a user of tool 20 creates one or more consoles 26 that are stored on the service provider's resources, such as server 54, the service provider may utilize a file based storage system for all of the parts of a rendered webpage (console, images, widgets, etc.). The file based storage system may include an inheritance or hierarchical mechanism that allows each console to be unique or based in some part on master elements. Thus, multiple consoles having some common elements and some different elements can be created using the common or master elements without having to recreate or redesign the common elements for each console. This saves the user of the tool 20 time and effort in creating consoles.

Tool 20 may operate on a framework maintained at service provider 54 that uses the PHP scripting language or it may use another language. The framework may he designed to allow third parties to custom create additional design widgets 28 that may be incorporated into embodiments of tool 20. Such customer created design widgets will operate with the framework used by service provider 54 so that embodiments of tool 20 may he modified and/or improved to provide greater functionality and ease of use to service provider 54's customers. The file handling and storage system used by the service provider 56 may provide a mechanism for the framework to speak to the console 26 and the widgets to inherit properties.

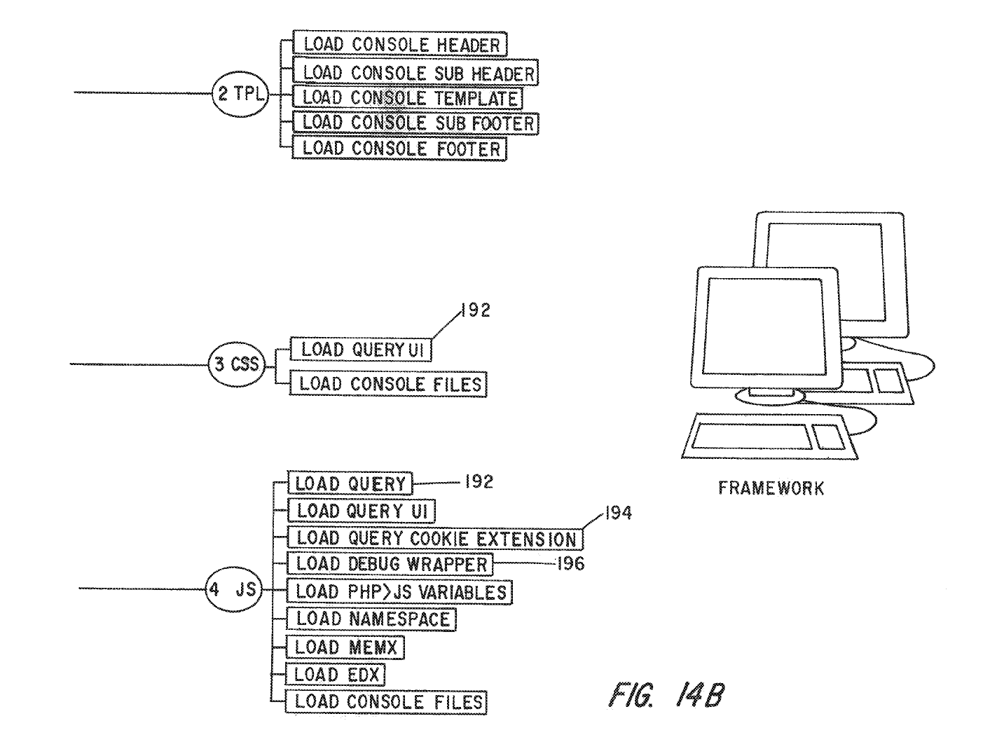

Referring to FIG. 14, assume at operation 150 that a client wishes to view a finished webpage. The client first enters a URL for that webpage on his work station terminal. Next, at block 152, the configuration file is loaded to render the site operational. In doing so, steps 154-160 are performed, resulting in the establishment of the rules under which the design tool will run.

Next, the coding conventions to be employed are established that will render the system operational. The capability of the webpage to be created or modified is dictated by different features and libraries to he used. These operations involve initializing an object name space (block 162), a member name space (block 164), dependency objects (block 166) and a remote session object (block 168).

At this point, it is also required that all of the codes that make the webpage work need to be entered, including the data (block 170) and console definitions (block 172). The console is created by the host name and, hence, customer identification is a required attribute. At block 174, a determination is made as to the files that are required to make the webpage work. There may be JavaScript (block 176), cascading style sheets (block 178), templates (block 180) and server-side script (block 182). The cascading style sheets (CSS) define such things as the type font to be used, the font size, its color hues, whether a shadow is to be included and similar attributes. TPL files (block 180) are simply static files that contain text.

The operations represented by blocks 170-182 provide an inventory of the items that are to be used in creating a webpage, the operations represented by blocks 184-190 process each of the items. For example, to make a JavaScript (JS) result in a displayable image, a library that includes the definition of all of its capabilities must be created. This is represented by block 192 in FIG. 14. Similarly, the ability to read cookies involves loading small data files at block 194. Block 196 reflects the fact that to correct for process failures, a debugging tool is entered.

It should now be apparent that to create a webpage using the web design tool described herein, the functionality represented by the software flow diagram of FIG. 14 is executed. The PHP page will be comprised of components that are assembled in accordance with established rules. By following the rules, various forms of media, text, graphics and the like can be assembled on the console and positioned, using drag-and-drop capability to create attractive webpages with a minimum of training and without program writing skills.

While the foregoing description describes several, embodiments of the present invention, it will be understood by those skilled in the art that variations and modifications to these embodiments may be made without departing from the spirit, and scope of the invention, as defined in the claims below.

1. A web development tool adapted to operate on a computer terminal having a display screen, said tool comprising:
a console displayable upon said screen, said console showing a composite image of what will be seen by a visitor to a webpage;
a plurality of webpage design widgets displayable upon, said screen, each of said plurality of webpage design widgets corresponding to a type of content that may be displayed in said console; and
a user interface that enables a webpage designer to drag and drop content from said webpage design widgets onto any location within said console whereby said content will be displayed on the webpage at the same relative location as the content is positioned on said console.

2. A web development tool of claim 1 wherein at least one of said webpage design widgets includes a web application programming interlace (API) that interfaces with an Internet accessible resource.

3. The web development tool of claim 1 wherein at least one of said webpage design widgets includes a web application programming Interface (API) that interfaces with an Internet accessible resource and said API includes a payment tool for accepting credit card information and charging an account associated with said credit card information.

4. The web development tool of claim 2 wherein said API includes a map tool for presenting maps of locations.

5. The web development tool of claim 2 wherein said API includes a social networking tool for interacting with a social network website.

6. The web development tool of claim 1 wherein said user interface allows said console to be resized by dragging a corner of said console.

7. The web development tool of claim 1 wherein said plurality of webpage design widgets enables a user to select properties for displaying content associated with said design widgets.

8. The web development tool of claim 7 wherein said properties include graphical characteristics selected horn a group consisting of size, shape, background, border and shadows.

9. The web development tool of claim 7 wherein said, properties further include display options that are contingent, upon said graphical interface, a particular visitor to the webpage or a particular type of visitor to the webpage.

10. The web development tool of claim 1 wherein said plurality of webpage design widgets includes a widget adapted to allow an advertisement to be placed on said webpage.

11. The web development tool of claim 1 wherein said webpage design widgets include a first widget for selecting a player, a second widget for selecting playlists, a third widget for selecting images, a fourth widget for selecting rich content and a fifth widget for selecting plain test.

12. The web development tool of claim 1 wherein the user interface includes at least one of a mouse, a keyboard and a touch screen.

13. A web development tool adapted to operate on a computer terminal having a display screen, said tool comprising:
a console displayable upon said screen, said console showing a composite image of what will be seen by a visitor to a webpage;
a plurality of webpage design widgets displayable upon said screen, each of said plurality of webpage design widgets corresponding to a type of content that may be displayed in said console;
a user interlace that enables a webpage designer to drag and drop content from said webpage design widgets onto any location within said console whereby said content will be displayed on the webpage at the same relative location as the content is positioned on said console; and
an upload feature adapted to allow said tool to upload said console including dependent data and scripting files over the Internet to a service provider, wherein said service provider communicates a software link to said uploaded console to a user of said tool.

14. A web development tool of claim 13 wherein said software link may be used to provide a link from a website maintained by an entity other than said service provider to said webpage.

15. A web development tool of claim 13 wherein at least one of said webpage design widgets includes a web application programming interface (API) that interfaces with an Internet accessible resource.

16. The web development tool of claim 15 and further including an upload feature adapted to allow said tool to upload said console over the Internet to a service provider, and wherein said service provider provides back end support for at least one of said APIs.

17. The web development tool of claim 16 wherein at least one of said APIs includes a mechanism for accepting on-line financial payments from a visitor to said website.

18. The web development tool of claim 17 wherein at least one of said webpage design widgets includes rule settings for allowing selected content to be displayed only to visitors to said website who have made an on-line financial payment.

19. The web development tool of claim 13 wherein said webpage design widgets include rule settings for allowing selected content to be displayed only to visitors to said website who meet selectable criteria.

20. The web development tool of claim 11 wherein said webpage design widgets include at least one widget enabling a user of the tool to create additional webpages on said console that links to said uploaded, console, where the console can be manually or dynamically resized to fit a user's display screen.

21. The web development tool of claim 13 wherein said upload feature is adapted to allow said tool to upload multiple different console designs over the Internet to a service provider, and said tool further allows a user of said tool to link said multiple different console designs to each other in selectable manners, and wherein said service provider communicates a software link to at least one of said uploaded consoles to the user of said tool.

22. The web development tool of claim 19 wherein at least one of said webpage design widgets enables a user of said tool to select different content for display on said webpage based upon different categories of visitors to said webpage.

23. The web development tool of claim 22 wherein said tool displays the different content to the user in the same manner as the content would be displayed to an actual visitor to the webpage, and said tool displays the different content to the user without requiring the user to actually visit the webpage.

24. The web development tool of claim 13 further including an enterprise configuration, adapted, to enable a first set of individuals to develop a layout for said console such, that a second set of individuals who use said tool are limited to designing webpages in conformance with said layout.

25. The web development tool of claim 24 wherein said first and second set of individuals are different but are both associated with said enterprise.

26. The web development tool of claim 13 wherein the user interface includes at least one of a mouse, a keyboard and a touch screen.
